(19) United States
(12) Patent Application Publication
(10) Pub. No.: US 2007/0074448 A1
(43) Pub. Date: Apr. 5, 2007

(54) Pest-control product

(75) Inventors: Osamu Igarashi, Yokohama-shi (JP); Noriyoshi Komiyama, Sagamihara-shi (JP)

Correspondence Address: CARR & FERRELL LLP, 2200 GENG ROAD, PALO ALTO, CA, 94303, US

(73) Assignee: Nix, Inc.

(21) Appl. No.: 11/541,372

(22) Filed: Sep. 29, 2006

(30) Foreign Application Priority Data
Sep. 30, 2005 (JP) 2005-288343

(51) Int. Cl. A01M 1/20

(52) U.S. Cl. 43/131; 43/132.1

(57) ABSTRACT

A pest-control product that has a simple structure and that can protect targets from pests, regardless of the shape and size of the targets, is provided. A pest-control product for protecting targets from pests includes: a plurality of pest-control members, which are made of a material containing a pest-control component; and a connector for connecting the pest-control members.

### CROSS-REFERENCES TO RELATED APPLICATIONS

This application relates to and claims priority from Japanese Patent Application No. 2005-288343, filed on Sep. 30, 2005, the entire disclosure of which is incorporated herein by reference.

### BACKGROUND

1. Technical Field

The present invention relates to a pest-control product that protects various targets from pests that can cause damage to the targets.

2. Related Art

Resin products containing repellents and having a generally triangular-pyramid shape have been introduced as pest-repellent products that contain components that have the effect of repelling arthropods, such as ants, spiders, and centipedes, and similar pests. If a pest-repellent product is attached to a trunk of a plant that bears produce like fruits and nuts, the pest-repellent product can, by the cumulative effect of the generally triangular-pyramid shape and the repellent, block various pests, such as imported red fire ants in particular, crawling up the trunk from the ground, and prevent damage caused by the pests to the produce (see U.S. Patent Publication No. 2002/0139061).

There is also a method for protecting target(s) from insects by attaching a pest-repellent product, which is made of a resin containing a pest-repelling component, to a target to be protected from pests, that has the pest-repelling component gradually released from the pest-repellent product, thereby protecting the target using the effect of the pest-repelling component (see JP-A-2004-357553).

However, since the pest-repellent products described in U.S. Patent Publication No. 2002/0139061 and JP-A-2004-357553 are structured so that they are placed directly on target(s) to be protected from the pests, the shapes of the targets are limited. In order to make the shape of the pest-repellent product conform to the shape of the targets, it is necessary to manufacture pest-repellent products of various shapes and sizes, which is uneconomical. Also, in the case of the aforementioned fire ants, an entire colony of fire ants enters outdoor transformers and control boxes for, for example, traffic signal controls in order to avoid rain and cold from everywhere, and the above-described pest-repellent products do not provide a sufficient solution to cover and protect the entire target device/equipment.

There are various forms of targets that may suffer damage caused by pests, and examples include produce, equipment or houses that are required to be hermetically sealed, equipment that needs to be placed outdoors, and equipment used outdoors (such as automobiles, motorcycles, and tractors). However, in the pest-repellent products described in the U.S. Patent Publication No. 2002/0139061 and JP-A-2004-357553, no consideration is paid to protection of the targets from pests by covering equipment of a comparatively large size, such as automobiles, motorcycles, and tractors, entirely with the pest-repellent products.

### SUMMARY

The present invention was devised in light of the circumstances described above. It is an object of the invention to provide a pest-control product with a simple structure that can protect target(s) from pests, regardless of the shape and size of the target.

According to an aspect of the invention, in order to achieve the object described above, a pest-control product for protecting a target from pests is provided. The pest-control product includes: a plurality of pest-control members, each of which at least partly is made of a material containing a pest-control component; and a connector for connecting the pest-control members.

This pest-control product is structured in such a way that the pest-control members are connected by a connector, and the number of pest-control members to be connected can be increased or decreased in accordance with the shape of the target to be protected from pests, and the pest-control product can easily conform to the shape of the target. Accordingly, the pest-control product can protect the target from pests, regardless of the shape and size of the target. Also, the pest-control members connected by the connector and used as a group are not scattered around apart from each other, so they can be easily collected after use. Accordingly, it is possible to prevent the occurrence of problems such as environmental contamination, and to enhance the traceability required for manufacturing quality management these days.

The word “pests” as used in relation to this invention not only indicates insects, but also is a generic term for small animals that may directly or indirectly damage, and thereby affect, humans, produce, machines, equipment, and so on. Examples of pests include ants, spiders, centipedes, cockroaches, geckos, mice, pigeons, crows, and any other similar animals.

The term “pest-control” used in relation to this invention means to expel, kill, or exterminate pests, protect targets from pests, and control (or inhibit) the growth of pests. Pest-control includes enticing pests in order to exert the pest-control effects described above.

Each pest-control member according to the invention can be made of, in its entirety, a material containing the pest-control component.

Also, in accordance with an embodiment of the invention, the pest-control product may be structured in such a way that the connector is flexible and can conform to the shape of the target. Because of this structure, the pest-control product can conform to the shape of the target more easily and protect the target from pests more reliably.

Moreover, the connector may have a net shape. In this case, the pest-control members may be placed at the intersections that define the net shape, or at other locations on the connector. If the pest-control members are placed at the intersections, a plurality of connectors may be coupled together by the pest-control members so as to form the connectors into a net shape, or the pest-control members may be placed at the intersections of a connector that was formed into a net shape in advance. Where the pest-control members are placed at the intersections of a connector that was formed into a net shape in advance, the pest-control members do not have to be placed at all the intersections.

In accordance with an embodiment of the invention's pest-control product, the pest-control members can be attached to or detached from the connector. Because of this structure, the pest-control member can be easily replaced, for example, at the end of its life. Also, if the pest-control product does not have to be used any longer, the pest-control members can be removed from the connector and stored.

In accordance with another embodiment of the invention's pest-control product, the pest-control members may be fixed to the connector.

Moreover, the connector may be made of a material containing the pest-control component. In this case, in addition to the aforementioned advantageous effects, it is possible to further enhance the pest-repelling effect.

In accordance with another embodiment of the invention's pest-control product, the pest-control member may have a through-hole part to allow the connector to pass through. Because of this structure, the pest-control member can be attached to the connector more easily.

Furthermore, in the pest-control product according to the invention, the pest-control component contained in the pest-control member may be arbitrarily selected from a chemical biocidal component, a growth control component, a repellent component, and an attractant component. Accordingly, it is possible to obtain a maximum of four kinds of pest-control members, i.e., pest-control members containing the chemical biocidal component, pest-control members containing the growth control component, pest-control members containing the repellent component, and pest-control members containing the attractant component.

Incidentally, for the plurality of pest-control members, it is preferable that at least two kinds of pest-control members containing different pest-control components are used.

The pest-control product according to the invention is structured in such a way that the connector is used to connect pest-control members made of a material containing a pest-control component, and the number of pest-control members to be connected can be increased or decreased in accordance with the shape of the target to be protected from the pests, and the pest-control product can easily conform to the shape of the target. As a result, the pest-control product can protect the target from pests, regardless of the shape and size of the target. Also, since the pest-control members are connected by the connector and used as a group, they can be easily collected after use. As a result, it is possible to prevent the occurrence of problems such as environmental contamination.

### BRIEF DESCRIPTION OF THE DRAWINGS

FIG. 1 is a perspective view of a pest-control product according to an embodiment of the invention.

FIG. 2 is a front view of a main body of a pest-control member, which is a component of the pest-control product shown in FIG. 1.

FIG. 3 is a side view of the main body shown in FIG. 2.

FIG. 4 is a front view of a cover for the pest-control member, which is a component of the pest-control product shown in FIG. 1.

FIG. 5 is a side view of the cover shown in FIG. 4.

FIG. 6 is a front view of the pest-control member in the state where the cover in FIG. 4 is to be put on the main body in FIG. 2.

FIG. 7 is a front view of the pest-control member, which is a component of the pest-control product shown in FIG. 1.

FIG. 8 is a perspective view of the pest-control product shown in FIG. 1 in the state where it is applied to a tractor.

FIG. 9 is a perspective view of a pest-control product according to another embodiment of the invention.

FIG. 10 is a front view of a pest-control member, which is a component of a pest-control product according to another embodiment of the invention, in the state where its cover is to be put on its main body.

FIG. 11 is a front view of the pest-control member, which is a component of the pest-control product according to the embodiment.

FIG. 12 is a front view of a pest-control member, which is a component of a pest-control product according to another embodiment of the invention, in the state where its cover is to be put on its main body.

FIG. 13 is a front view of the pest-control member, which is a component of the pest-control product according to the embodiment.

FIG. 14 is a front view of a pest-control member, which is a component of a pest-control product according to another embodiment of the invention, in the state where its cover is to be put on its main body.

FIG. 15 is a front view of the pest-control member, which is a component of the pest-control product according to the embodiment.

FIG. 16 is a perspective view of a pest-control product according to another embodiment of the invention.

FIG. 17 is a side view of a pest-control member according to another embodiment of the invention.

FIG. 18 is a perspective view of the pest-control member according to the embodiment.

FIG. 19 is a side view of a pest-control member according to another embodiment of the invention.

FIG. 20 is a perspective view of the pest-control member according to the embodiment.

FIG. 21 is a perspective view of a pest-control product according to another embodiment of the invention.

FIG. 22 is a perspective view of a pest-control product according to another embodiment of the invention.

FIG. 23 is a perspective view of a pest-control product according to another embodiment of the invention.

FIG. 24 is a perspective view of a pest-control product according to another embodiment of the invention.

### DETAILED DESCRIPTION OF PREFERRED EMBODIMENTS

Pest-control products according to preferred embodiments of the invention will be described below with reference to the attached drawings. The embodiments described below are for the purpose of describing this invention, but the invention is not limited only to those embodiments. Accordingly, this invention can be utilized in various ways unless those utilizations depart from the gist of the invention.

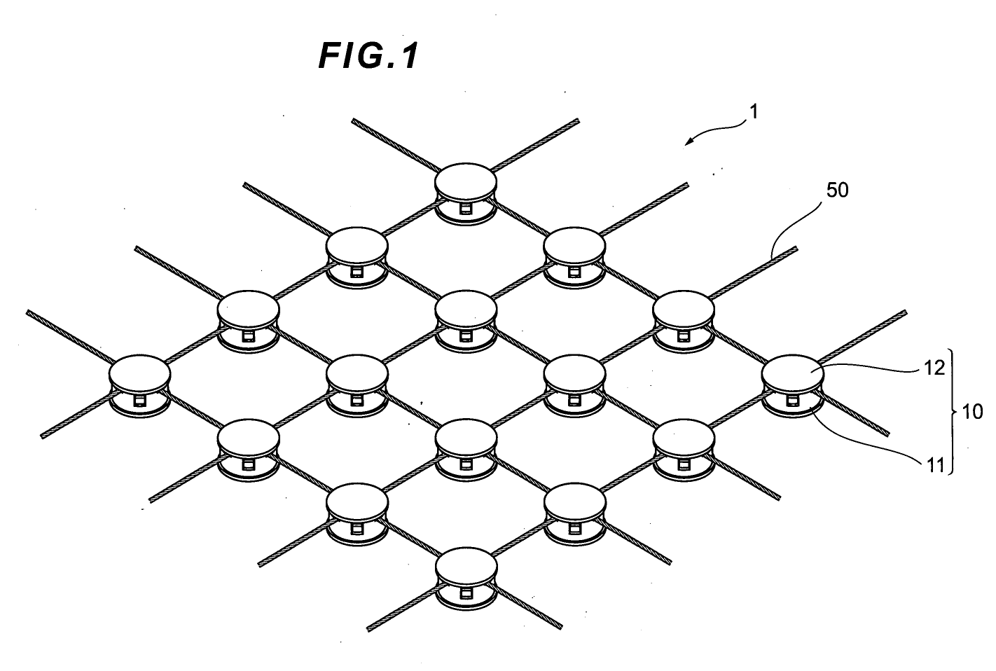

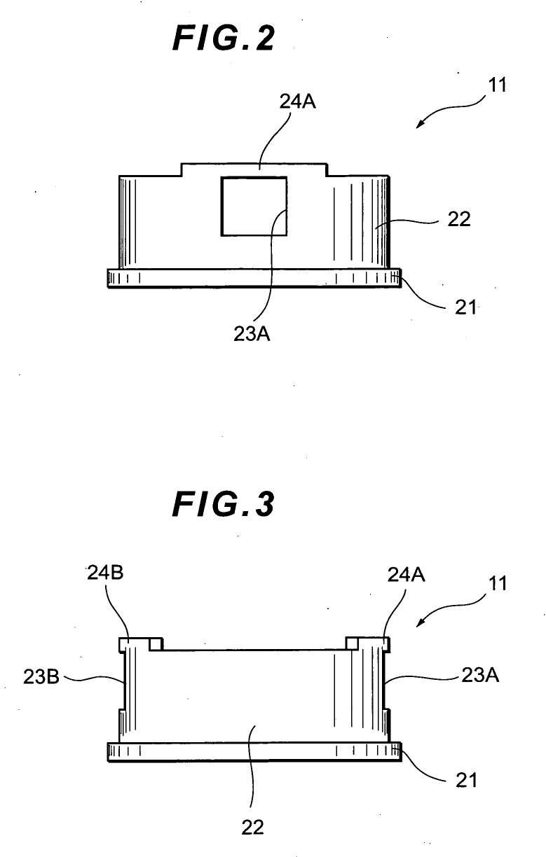

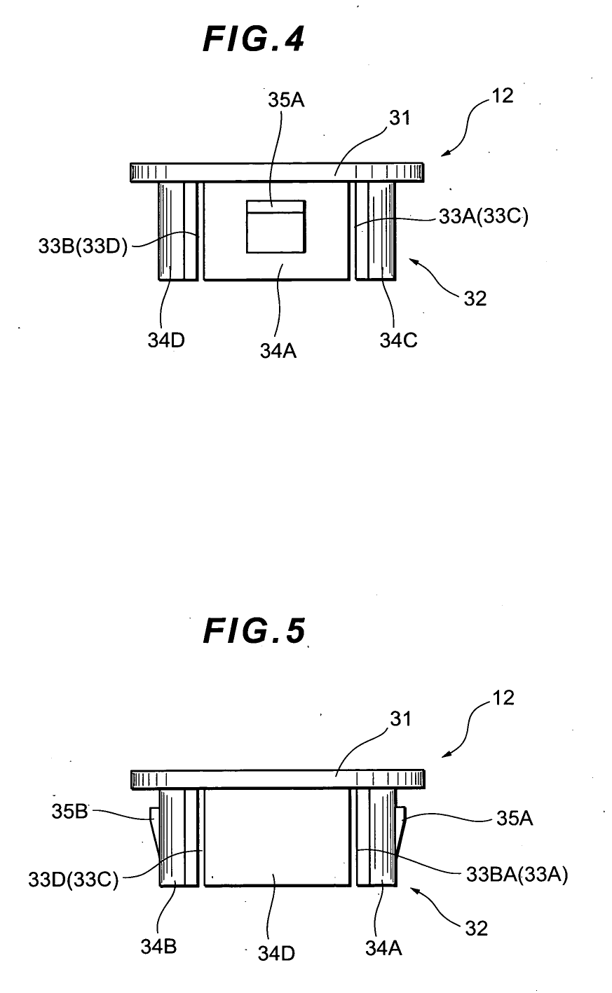

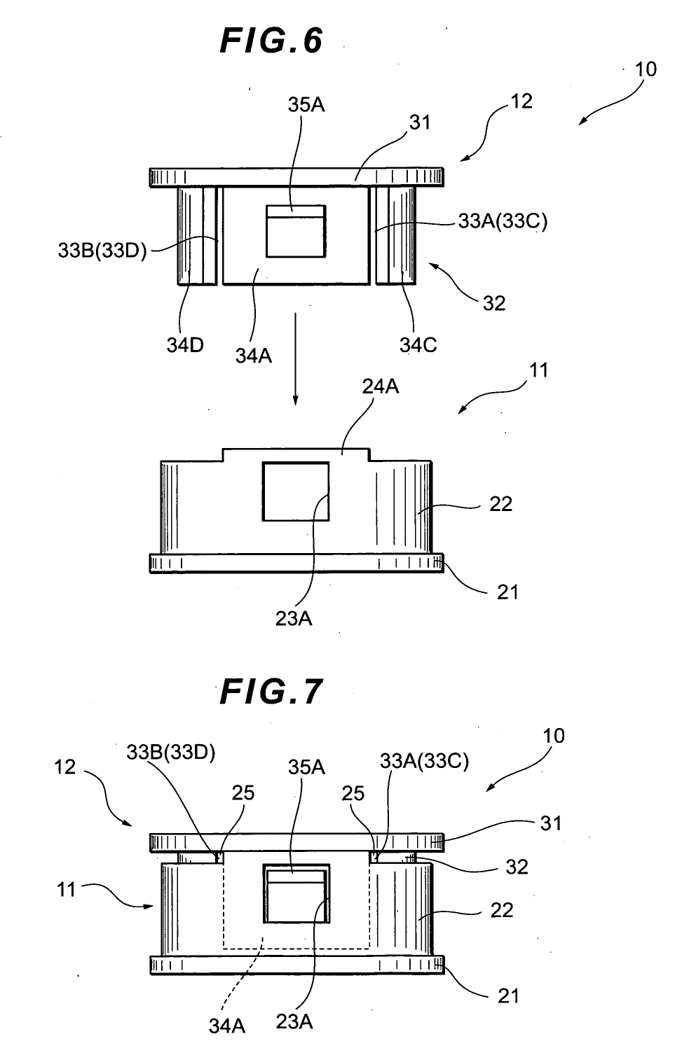

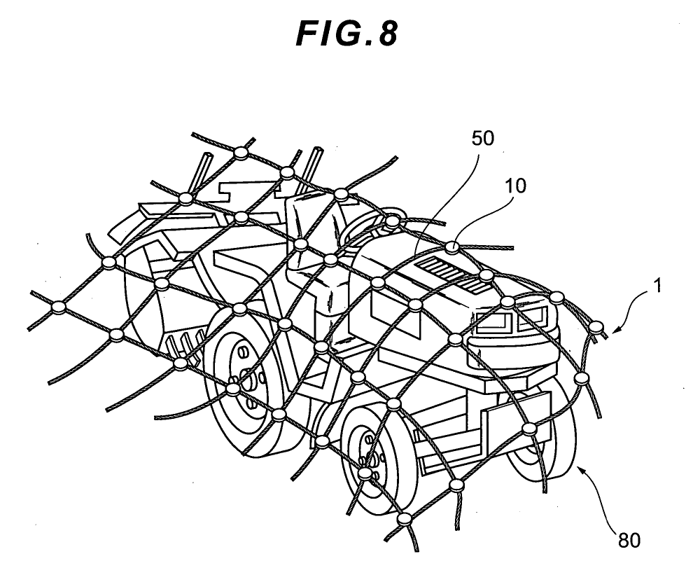

FIG. 1 is a perspective view of a pest-control product according to an embodiment of the invention. FIG. 2 is a front view of a main body of a pest-control member, which is a component of the pest-control product shown in FIG. 1. FIG. 3 is a side view of the main body shown in FIG. 2. FIG. 4 is a front view of a cover of the pest-control member, which is a component of the pest-control product shown in FIG. 1. FIG. 5 is a side view of the cover shown in FIG. 4. FIG. 6 is a front view of the pest-control member in the state where the cover in FIG. 4 is to be put on the main body in FIG. 2. FIG. 7 is a front view of the pest-control member, which is a component of the pest-control product shown in FIG. 1. FIG. 8 is a perspective view of the pest-control product shown in FIG. 1 in the state where it is applied to a tractor.

As shown in FIG. 1, a pest-control product 1 according to this embodiment includes a plurality of pest-control members 10 and a net 50 that functions as a connector to connect the pest-control members 10.

Various types of commercially available nets that are made of, for example, polyethylene or nylon can be used as the net 50.

A pest-control member 10 includes, as shown in FIGS. 1 to 7, a generally cylindrical main body 11 and a cover 12 that is placed on the main body 11, with the cover able to be removed from the main body 11 as necessary. The main body 11 and the cover 12 are made of a resin containing a pest-control component.

The main body 11 and the cover 12 can be molded using various known molding methods such as injection molding, extrusion molding, press molding, blow molding, and machining molding. There is no particular limitation on the shape of the pest-control member 10 according to the invention, and the pest-control member 10 can be formed into any shape, such as a flat plate, bar, cylindrical, comb, or spherical shape. Also, the pest-control member 10 according to the invention can be formed by two-color or multi-color molding by using, for example, normal resin compositions or metals so that only a desired portion of the pest-control member 10 is formed to be a structural member having pest-control properties.

The pest-control component can include chemical biocidal components, growth control components, repellent components, and attractant components. Examples of the pest-control component include compounds with pest-control properties, compounds with pest-killing/harming properties, and compounds with pest antifeedant properties and pest growth control properties. Possible specific examples are listed as follows: chloronicotinyl insecticides such as imidaclopride; compounds composed of neophil radicals having silicon atoms such as silafluorophen; carbamate compounds such as benflacarb, alanycarb, methoxydiazon, carbosufan, fenobucarb, carbaryl, methomyl, propoxur, and phenoxycarb; pyrethroid compounds such as pyrethrin, allethrin, dl,d-T80-allethrin, d-T80-resmethrin, bioallethrin, d-T80-phthalthrin, phthalthrin, resmethrin, furamethrin, propathrin, permethrin, acrinathrin, ethofenprox, tralomethrin, phenothrin, d-phenothrin, fenvalerate, empenthrin, prallethrin, tefluthrin, and benfluthrin; organic phosphorous compounds such as dichlorvos, fenitrothion, diazinon, malathion, promophos, fenthion, trichlorfon, naled, temephos, fenchlorphos, chlorpyrifosmetyl, cyafos, calchlophos, azamethiphos, pyridafenthion, propetamphos, and chlorpyrifos; and isomers, derivatives, and analogues of the aforementioned compounds. Also, compounds that control the growth of small animals, such as methoprene, pyriproxyfen, kinoprene, hydroprene, deohenoran, NC-170, flufenoxuron, diflubenzuron, lufenuron, and chlorfluazuron can be listed as examples. Examples-of miticides include kelsen, chlorfenapyr, tebufenpyrad pyridaben, milbemectin, and fenpyroximate. Examples of rodenticides include scilliroside, norbomide, zinc phosphide, thallium sulfate, yellow phophor, ANTU, warfarin, endocide, coumarin, cumatetralyl, promadioron, and difetiaron.

As the resin containing the pest-control component, at least one type of resin is selected from, for example, polyacetal resin, polyamide resin, acrylonitrile-butadiene-styrene copolymer (ABS resin), polystyrene (PS), polyethylene (PE), polypropylene (PP), polycarbonate (PC), polyvinyl chloride resin (PVC), polybutylene terephthalate (PBT), polyethylene terephthalate (PET), polyphenylene oxide (PPO), and thermoplastic elastomers obtained by mixing the above-listed resins with elastomers. It is also preferable that a compound to dissolve and maintain the pest-control component in the resin and give controlled-release properties to the resin is contained in the resin.

As a compound having the controlled-release properties, at least one type of compound can be selected from, for example, sulfonamide derivatives, sulfonate derivatives, carboxylic acid amide derivates, and carboxylate derivatives.

As described above, inclusion of the compound having the controlled-release properties in the resin enables the pest-control component to be released over a long period of time.

The main body 11 has a generally disk-shaped base 21 and a generally cylindrical wall 22 that extends upright from a position near the periphery of the base 21. In the wall 22, engagement holes 23A and 23B for engaging with engagement protrusions 35A and 35B of the cover 12, described later in detail, are formed at respective opposite positions (which are apart by 180 degrees). Also, raised parts 24A and 24B that protrude from an end face of the wall 22 opposite the base 21 are formed respectively on that end face of the wall 22 in areas where the engagement holes 23A and 23B are made. When the cover 12 is put on the main body 11 (see FIG. 7), these raised parts 24A and 24B come into contact with a top plate 31 of the cover 12 and define through-hole parts 25 (see FIG. 7), between the main body 11 and the cover 12, for allowing the net 50, described later in detail, to pass through.

The cover 12 has a generally disk-shaped top plate 31 and a generally cylindrical wall 32 that extends perpendicularly from a position near the periphery of the top plate 31. The wall 32 is partitioned by four slits 33A, 33B, 33C, and 33D into four parts 34A, 34B, 34C, and 34D. The parts 34A and 34B are formed to have almost the same circumferential width with that of the raised parts 24A and 24B of the main body 11. When the cover 12 is put on the main body (see FIG. 7), parts of the slits 33A and 33B are located on both sides of the raised part 24A and parts of the slits 33C and 33D are located on both sides of the raised part 24B. The (exposed) parts of the slits 33A, 33B, 33C, and 33D that are located on both sides of the raised parts 24A and 24B constitute through-hole parts 25 (see FIG. 7), described later in detail, for allowing the net 50 to pass through.

Moreover, the parts 34A and 34B have respective engagement protrusions 35A and 35B that engage with the engagement holes 23A and 23B in the main body 11. As shown in detail in FIG. 5, each engagement protrusion 35A and 35B has a hook shape with an inclined plane so that its protrusion amount gradually decreases from the top plate 31 side to its lower end as shown in FIG. 5.

The pest-control member 10 having the above-described structure is attached to an intersection of the net 50 by putting the cover 12 on the main body 11 and having the engagement protrusions 35A and 35B engage with the engagement holes 23A and 23B in such a matter that the four strings extending from the intersection of the net 50 pass through the respective four through-hole parts 25, which are formed on both sides of the raised parts 24A and 24B. In this way, the pest-control product 1 in FIG. 1 is formed.

In order to remove the pest-control member 10 from the net 50, it is only necessary to release the engagement between the engagement holes 23A and 23B and the engagement protrusions 35A and 35B.

Since in this pest-control product 1 the net 50 is made of a flexible material, even if the pest-control product 1 is applied to a large-size target with a complicated shape, like a tractor 80 as shown in FIG. 8, the pest-control product 1 can cover the tractor 80 in conformity with the shape of the tractor 80 and protect the tractor 80 from pests. Also, since the pest-control members 10 are attached to the net 50, the pest-control members 10 are connected by the connector and used as a group and can be easily collected after use.

This embodiment has described the case where the pest-control members 10 are attached to the intersections of the net 50. However, the attachment positions of the pest-control members 10 are not limited to the intersections of the net 50, and the pest-control members 10 may be attached to other parts of the net 50. Also, the pest-control members 10 do not have to be attached to all the intersections of the net 50. Of course, the attachment positions and the number of pest-control members 10 to be attached can be changed as desired.

Furthermore, this embodiment has described the case where both the main body 11 and the cover 12 are made of a material containing the pest-control component. However, the invention is not limited to this example, and either the main body 11 or the cover 12 may be made of a material containing the pest-control component. The case where a resin is used as the material was described above. However, the material is not limited to resin, and any material can be selected as appropriate, according to the environment and conditions where the pest-control product 1 is used, as long as the material contains the pest-control component and can exhibit the effect of the pest-control component.

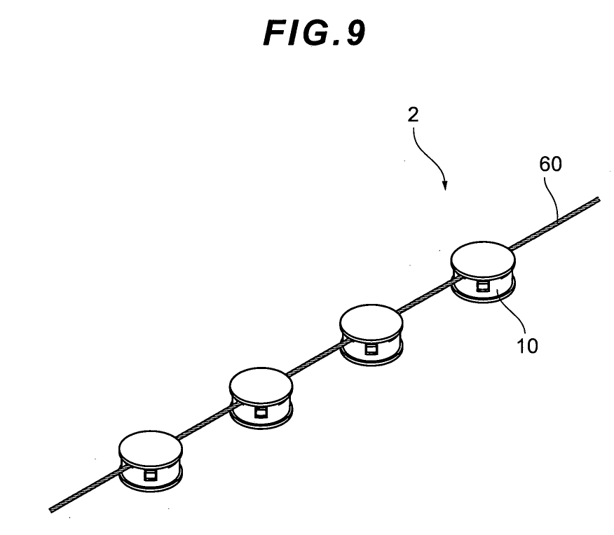

The connector for connecting the pest-control members 10 is not limited to the net 50 and, for example, a rope 60 may be used as the connector as shown in FIG. 9. Of course, a connector having other structures may be used as long as it can connect a plurality of pest-control members 10; for example, a sheet or a panel may be used to connect the respective pest-control members by forming attachment parts for the pest-control members 10 on the sheet or the panel and attaching the pest-control members 10 to those parts of the sheet or the panel. In this case, the sheet or the panel may be made of a material, either flexible or nonflexible. The connector itself may be made of a material containing the pest-control component.

The structure of the pest-control member 10 is not limited to that described above, and various forms of the pest-control member 10 are possible as long as the pest-control member 10 is made of a material containing the pest-control component, and can be connected by the connector.

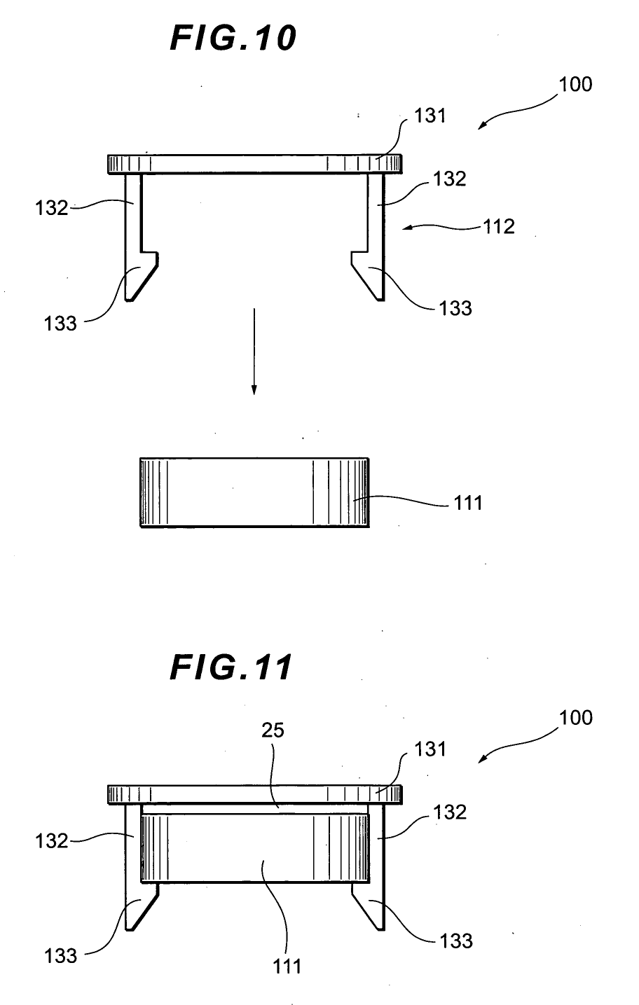

For example, the pest-control member according to the invention may be structured as shown in FIGS. 10 and 11. Specifically speaking, a pest-control member 100 shown in FIGS. 10 and 11 has a main body 111 and a cover 112. The main body 111 and the cover 112 are made of a material containing the pest-control component.

The main body 111 has a generally cylindrical shape. The cover 112 has a generally disk-shaped top plate 131 and a plurality of legs 132 extending perpendicularly from a position near the periphery of the top plate 131. Claws 133 are formed at the top ends of the legs 132. When the cover 112 is put on the main body 111, these claws 133 engage with the bottom face of the main body 111. Accordingly, the main body 111 is held by the cover 112 as shown in FIG. 11 so that the cover 112 can be detached from the main body 111 as necessary. The main body 111 is formed so that spaces are formed between the main body 111 and the top plate 131 of the cover 112 when the main body 11 1 is held by the cover 112. These spaces constitute through-hole parts 25 (see FIG. 11) for allowing the connector to pass through.

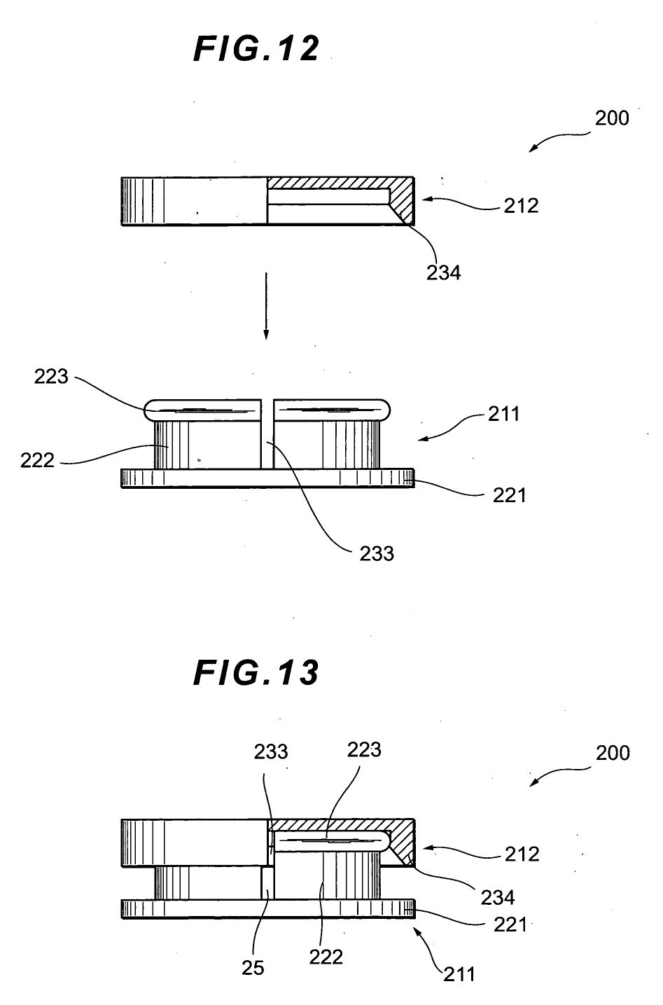

Furthermore, the pest-control member according to the invention may be structured as shown in FIGS. 12 and 13. Specifically speaking, a pest-control member 200 shown in FIGS. 12 and FIG. 13 has a main body 211 and a cover 212. The main body 211 and the cover 212 are made of a material containing the pest-control component.

The main body 211 has a generally disk-shaped base 221, a generally cylindrical column 222 extending upright from the base 221, and a generally disk-shaped flange 223 formed on top of the column 222. A groove 233 that passes through the column 222 and the flange 223 along the diameter is formed in an area corresponding to the diameter of the column 222 and the flange 223 as seen from above.

The cover 212 has a generally disk-like shape and its cross-section is generally U-shaped. A claw 234 is formed along the top end of the inside edge of the cover 212. When the cover 212 is put on the main body 211, this claw 234 engages with the flange of the main body 211, with the claw 234 able to be detached from the flange 223 as necessary. As a result, the main body 211 is held by the cover 212 as shown in FIG. 13, with the cover 212 able to be detached from the main body 211 as necessary. The cover 212 is formed so that a space is formed between the main body 211 and the base 221 when the cover 212 is put on the main body 211. The space formed by the groove 233 of the main body 211 and the base 221 constitutes a through-hole part 25 (see FIG. 13) for allowing the connector to pass through.

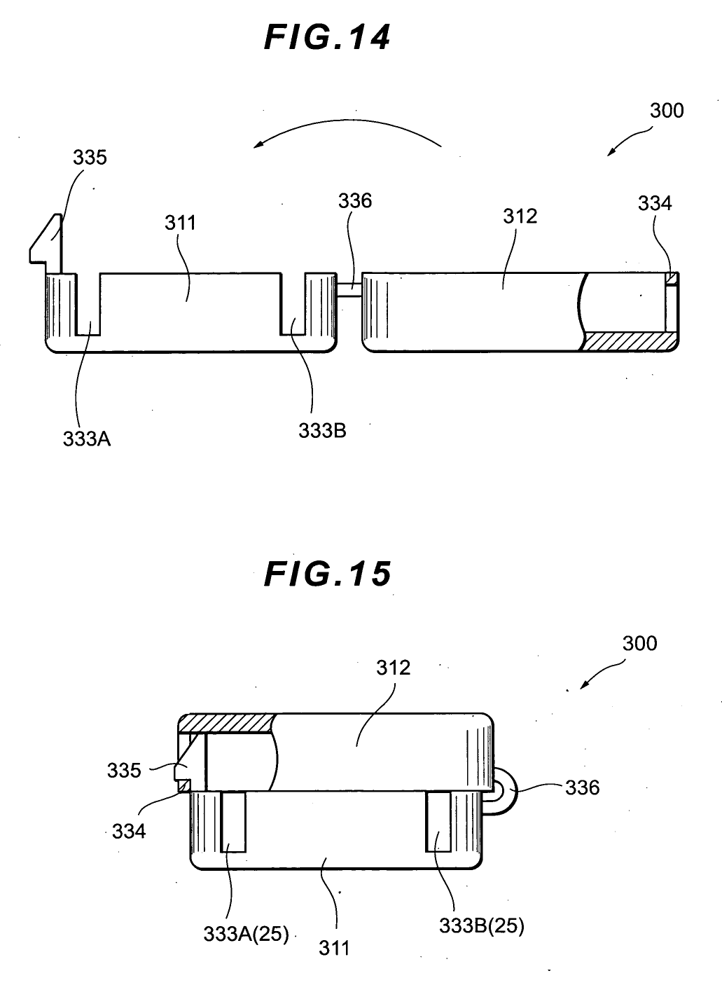

Furthermore, the pest-control member according to the invention may be structured as shown in FIGS. 14 and 15. Specifically speaking, a pest-control member 300 shown in FIGS. 14 and 15 has a main body 311 and a cover 312. The main body 311 and the cover 312 are made of a material containing the pest-control component.

The main body 311 has a generally disk-like shape, and two grooves 333A and 333B that are parallel to the diameter of the main body 311 as seen from above pass through the main body 311. Also, a claw 335 protrudes from the main body 311 and engages with an engagement part 334 of the cover 312 described below in detail.

The cover 312 has a generally disk-like shape, is hollow, and is connected via a hinge 336 to the main body 311. This cover 312 has the engagement part 334 for engaging with the claw 335, with it able to be detached from the claw 335 as necessary, and the engagement part 334 is located at a position corresponding to the claw 335 when the cover 312 is put on the main body 311. When the cover 312 is put on the main body 311, the grooves 333A and 333B in the main body 311 constitute through-hole parts 25 (see FIG. 15) for allowing the connector to pass through.

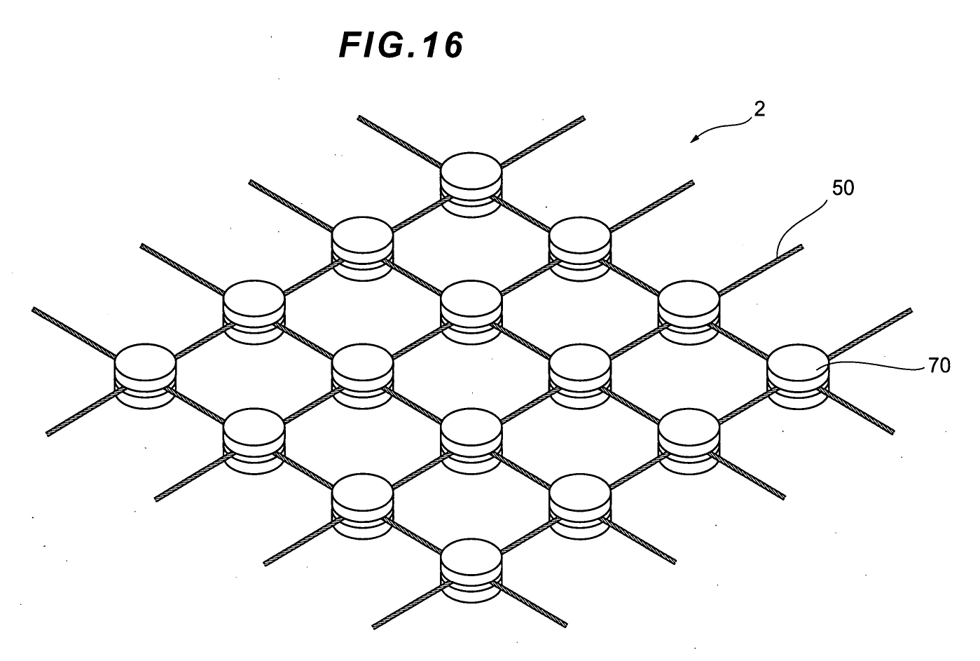

Furthermore, as shown in FIG. 16, a pest-control product 2 according to the invention may be structured in such a way that pest-control members 70 are fixed to the net 50 in advance (i.e., the pest-control members 70 are not detachable from the net 50). Also, other structures in which the pest-control members are fixed to the connector in advance may be applied.

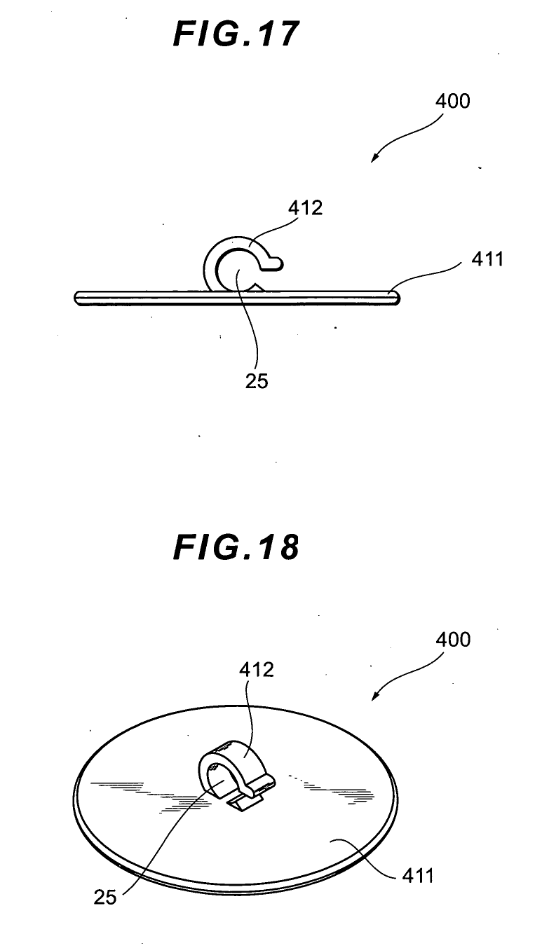

Moreover, the pest-control member according to the invention may be structured as shown in FIGS. 17 and 18. Specifically speaking, a pest-control member 400 shown in FIGS. 17 and 18 has a generally disk-shaped main body 411 and a generally C-shaped hook 412 formed on the main body 411. The main body 411 and the hook 412 are made of a material containing the pest-control component. The inside space of the hook 412 constitutes a through-hole part 25 for allowing the connector to pass through.

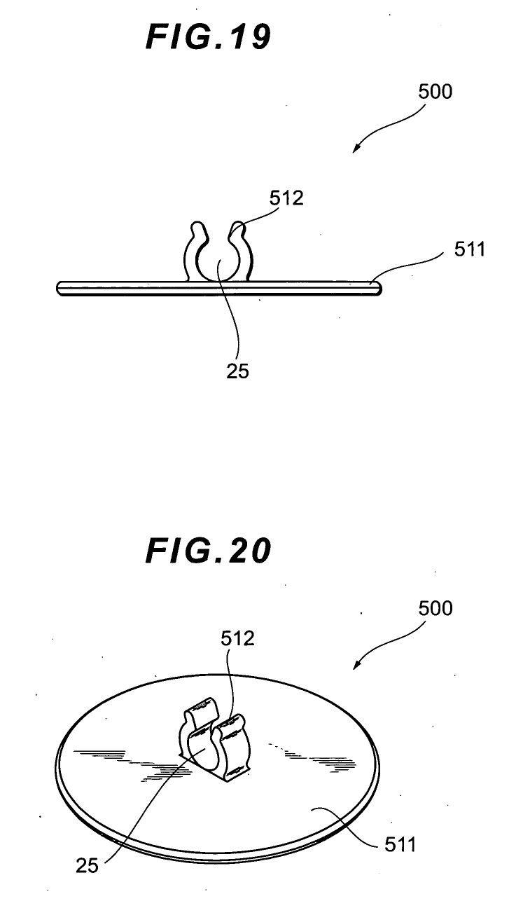

Furthermore, the pest-control member according to the invention may be structured as shown in FIGS. 19 and 20. Specifically speaking, a pest-control member 500 shown in FIGS. 19 and 20 has a generally disk-shaped main body 511 and generally C-shaped hooks 512 that are formed on the main body 511 and whose top ends are open. The main body 511 and the hooks 512 are made of a material containing the pest-control component. The inside space of the hooks 512 constitutes a through-hole part 25 for allowing the connector to pass through.

The pest-control member according to the invention may be at least one of: a pest-control member containing a chemical biocidal component, a pest-control member containing a growth control component, a pest-control member containing a repellent component, and a pest-control member containing an attractant component.

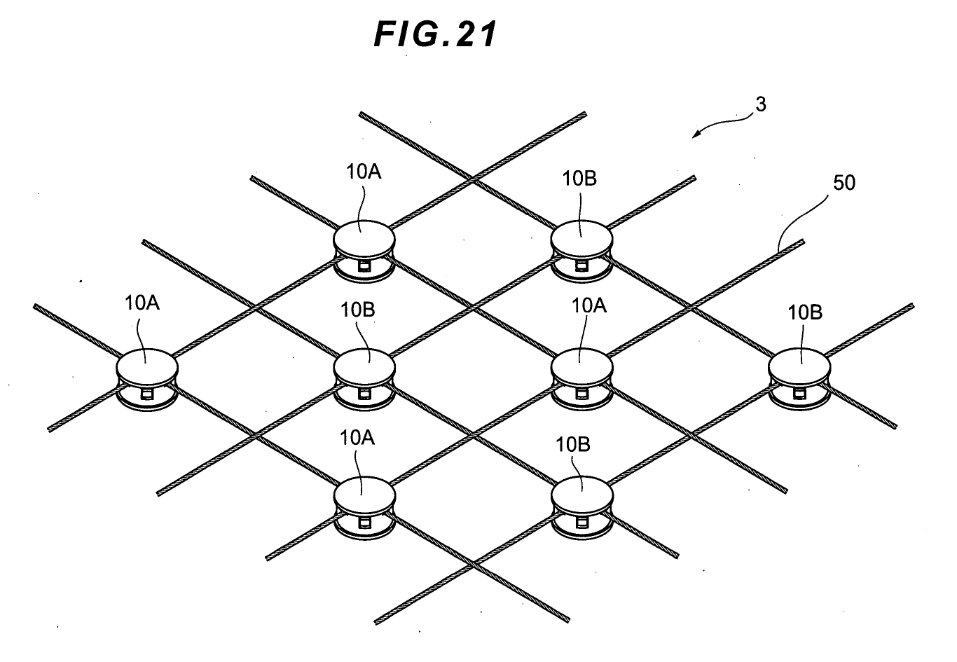

As shown in FIG. 21, a pest-control product 3 in which pest-control members 10A containing the chemical biocidal component and pest-control members 10B containing the attractant component are placed on the net 50 may be provided. In this case, the pests can be exterminated by having the pest-control members 10B containing the attractant component attract the pests and the pest-control members 10A containing the chemical biocidal component chemically kill the pests drawn to the pest-control product 3.

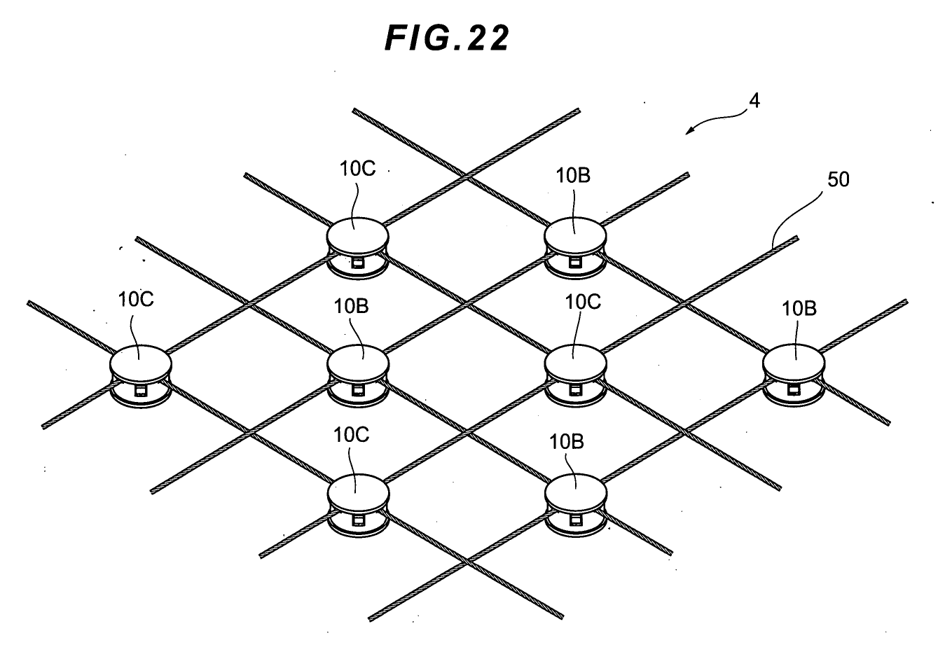

Also, as shown in FIG. 22, a pest-control product 4 in which pest-control members 10C containing the growth control component and the pest-control member 10B containing the attractant component are placed on the net 50 may be provided. In this case, pests can be exterminated by having the pest-control members 10B containing the attractant component attract the pests and controlling (inhibiting) the growth of the pests drawn to the pest-control product 4.

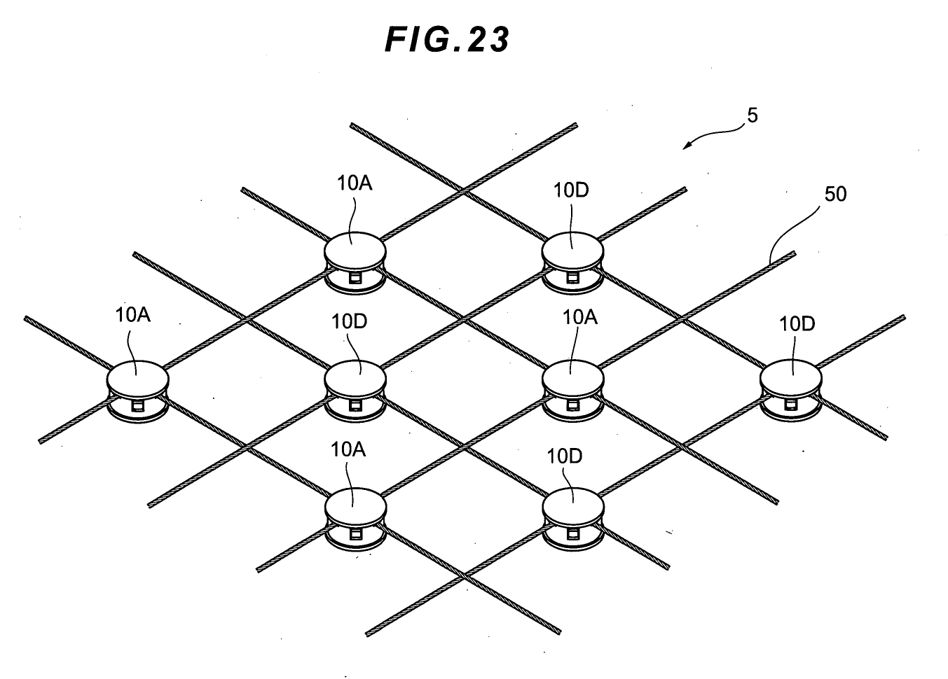

Furthermore, as shown in FIG. 23, a pest-control product 5 in which the pest-control members 10A containing the chemical biocidal component and pest-control members 10D containing the repellent component are placed on the net 50 may be provided. In this case, the pests can be exterminated by using the pest-control members 10D containing the repellent component to keep pests away from the target; and even if some pests come close to the target, the pest-control members 10A containing the chemical biocidal component can chemically kill the pests.

The pest-control multi-functions can be enhanced by using combinations of the pest-control members 10A to 10D as appropriate, as shown in FIGS. 21 to 23. Examples of combinations of the pest-control members 10A to 10D, other than those described above, may include: a combination of the pest-control members 10A containing the chemical biocidal component and the pest-control members 10C containing the growth control component; and a combination of the pest-control members 10C containing the growth control component and the pest-control members 10D containing the repellent component. Also, three or more kinds of the pest-control members 10A to 10D may be used. The number and positions of the pest-control members 10A to 10D to be placed on the connector can be decided as desired.

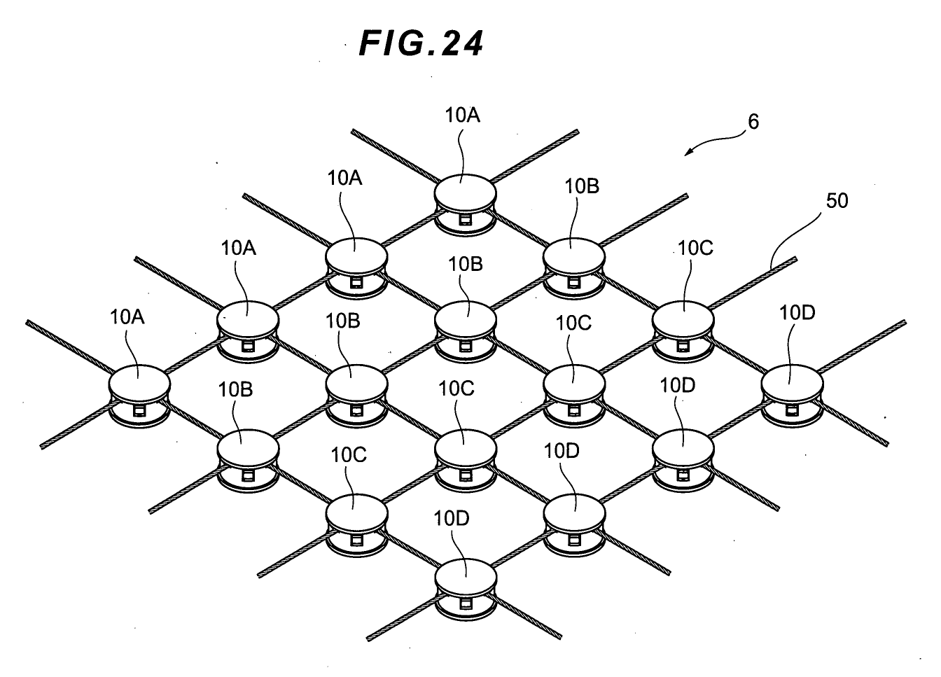

Furthermore, as shown in FIG. 24, a pest-control product 6 in which the pest-control members 10A containing the chemical biocidal component, the pest-control members 10B containing the attractant component, the pest-control members 10C containing the growth control component, and the pest-control members 10D containing the repellent component are placed on the net 50 may be provided. As a result, pests can be exterminated more effectively. Specifically speaking, the effects of the chemical biocidal component, the growth control component, the repellent component, the attractant component on the pests may differ depending on the types of pests, and it is rare that only one kind of pest exists at places like outdoors, so it is normally necessary to exterminate multiple kinds of pests, and it is possible to control multiple kinds of pests by using multiple kinds (four kinds in this specification) of pest-control members 10A to 10D.

Furthermore, for the pest-control products 3 to 6 shown in FIGS. 21 to 24, a connector having other structures such as a rope 60, a sheet, or a panel can be used instead of the net 50.

What is claimed is:

1. A pest-control product for protecting a target from pests, the pest-control product comprising:
a plurality of pest-control members, each of which is at least partly made of a material containing a pest-control component; and
a connector for connecting the pest-control members.

2. The pest-control product according to claim 1, wherein each of the pest-control members is made of, in its entirety, a material containing the pest-control component.

3. The pest-control product according to claim 1, wherein the connector is flexible and can conform to the shape of the target.

4. The pest-control product according to claim 1, wherein the connector has a net shape.

5. The pest-control product according to claim 1, wherein the pest-control members can be attached to/detached from the connector.

6. The pest-control product according to claim 1, wherein the pest-control members are fixed to the connector.

7. The pest-control product according to claim 1, wherein the connector is made of a material containing the pest-control component.

8. The pest-control product according to claim 1, wherein each of the pest-control members has a through-hole part for allowing the connector to pass through.

9. The pest-control product according to claim 1,. wherein the pest-control component is at least one of a chemical biocidal component, a growth control component, a repellent component, and an attractant component.

10. The pest-control product according to claim 9, wherein at least two types of pest-control members containing different pest-control components are used.
